(19) United States
(12) Patent Application Publication
(10) Pub. No.: US 2023/0308405 A1
(43) Pub. Date: Sep. 28, 2023

(54) Intelligent System Enabling Automated Scenario-Based Responses in Customer Service

(71) Applicant: LIVECHAT SOFTWARE S.A, WROCLAW (PL)

(72) Inventor: Dariusz Zabrzenski, Kamieniec Zabkowick (PL)

(21) Appl. No.: 17/958,406

(22) Filed: Oct. 2, 2022

Related U.S. Application Data
(63) Continuation-in-part of application No. 16/117,084, filed on Aug. 30, 2018, now abandoned.

(51) Int. Cl. H04L 51/046; H04L 67/133

(52) U.S. Cl. CPC H04L 51/046; H04L 67/133

(57) ABSTRACT

A communication system for real-time communication between at least a first and a second user is disclosed. The system includes a chatbot operating in connection with an Internet browser. The system includes a scenario builder arranged on a processor at the first user, along with a chatbot infrastructure, data storage and appropriate interface programming Use is made of an API configured to facilitate communication between the chatbot infrastructure and communication channels, while a data parsing mechanism, also arranged on a server, is used to cluster data of the chat content and provide suggestions for chatbot responses.

### CROSS REFERENCE TO RELATED APPLICATIONS

This application is a continuation in part of and claims the benefit of priority from co-pending and co-invented U.S. patent application Ser. No. 16/117,084, filed on Aug. 30, 2018, the content of which is hereby incorporated by reference.

### BACKGROUND OF THE INVENTION

Currently, providing fast and adequate online support for the customer is one of the most influential business growth dimensions. Instant communication channels are the most widely applied means of communication to ensure customer support due to instant effect on the problem or question reported by the customer. Customizing conversations with real end users while at the same time limiting costs, is an ever-present goal to which the presently disclosed embodiments offer solutions which enable a scenario-based system to provide a form of automated or automating customer service in at least a form of conversation.

Conventional, agent-served systems often fail when it comes to providing timely responses and instant message detection. Such conventional solutions are often costly and carry with it additional burdens such as providing solutions and answers to customers' needs and questions, oftentimes in a local language of the customer and/or the business. The present embodiments address some of these important needs via scenario-based actions built in and around an automated response system. Furthermore, the applied-for patent application provides a solution to the issue of content to be used during scenario building thanks to the suggestion capacity based on the clustered data from the chat content.

A generally related technology may be found described in U.S. Pat. No. 6,401,061 dated Jun. 4, 2002.

The granted patent makes use of intelligent processing and retrieval of textual information in language processing to achieve a responsive system enabling natural language phrases qualification.

### BRIEF SUMMARY OF THE INVENTION

Presently disclosed embodiments set out a scenario-based intelligent response system which can be implemented with and in different chat solutions related at least in part to agent-customer conversations and/or customer service in general as may be provided by an agent through online chats. The embodiments enable and otherwise set out not only an intelligent method but also an accessible interface which allows or makes possible for a user to prepare its own bot scenario of a conversation which may transpire between agent and customer. Such embodiments may be integrated with any chat-based solution designed to facilitate conversations, data exchange and transfer, provided that such software enables API (Application Programming Interface) access. Furthermore, the embodiment of the invention provides a data clustering system that enables chatbot scenario elements based on the chat content exchanged between agent and customer or agent and chatbot to provide easier and faster possibility to configure chatbot scenarios.

The current growth of customer-based sales and a need for easy and accessible contact places enormous pressures and burdens on almost all types of businesses. The disclosed embodiments help to achieve effective onboarding, sales assistance or any other such customer service which, in a “human-like” manner, replies to customers' requests. In fact, usage of the present embodiments' integration is a matter of a scenario to be implemented by a user. It enables the automation of concrete spheres of contact with a customer as well as provides a means for natural communication based on trigger qualifiers which begin the process of content to be sent and displayed through an integration into the chat application with the embodiment.

The use of the embodiment of a solution enables the customization of conversations with customers as may be broken down by industry, type of product, or any other qualification based upon natural language qualifiers which are introduced by the user who implements the presently disclosed embodiments into their chat solutions. High flexibility of the embodiments enables integrations and implementations with different types of conversation tools, themselves enabling and enabled by API access. Data clustering mechanism and chatbot step suggesting mechanism further enable the creation of chatbot suggestions while the scenario is being built by the embodiment user.

The functionality of integration between the embodiments and any chat solution is enabled through application API. Furthermore, a chatbot created through these embodiments can be trained to recognize and accept replies as qualifying under an entity based upon a confidence score.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

In the following, advantageous examples of the invention are explained with reference to the accompanying figures, wherein:

FIG. 1 depicts an example of chatbot scenario based upon predefined triggers including A/B Test, Flow, Create a ticket, success or failure to the programmed scenario criterions;

FIG. 2 depicts scenario-making process and presents an interface to set up an attribute as an element of chatbot scenario;

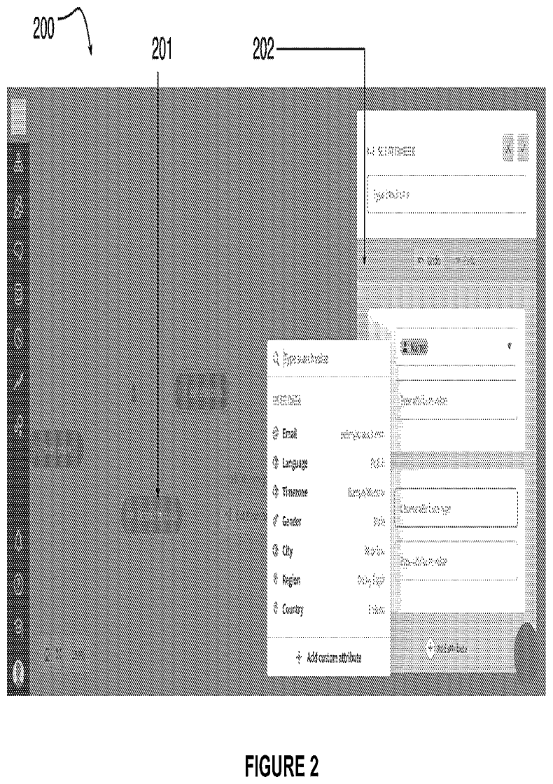

FIG. 3 depicts an example conversation performed by a chatbot with chatbot responses displayed

FIG. 4 depicts a simplified communication flow between the embodiment of the invention and the channel provider;

FIG. 5 depicts a simplified communication flow between the embodiment of the invention and the channel provider with data clustering included;

FIG. 6 depicts a detailed dataflow when it with clustering; and

FIG. 7 depicts a detailed flow of data matching and clustering with pooling and minimum requirements for data cluster creation being included.

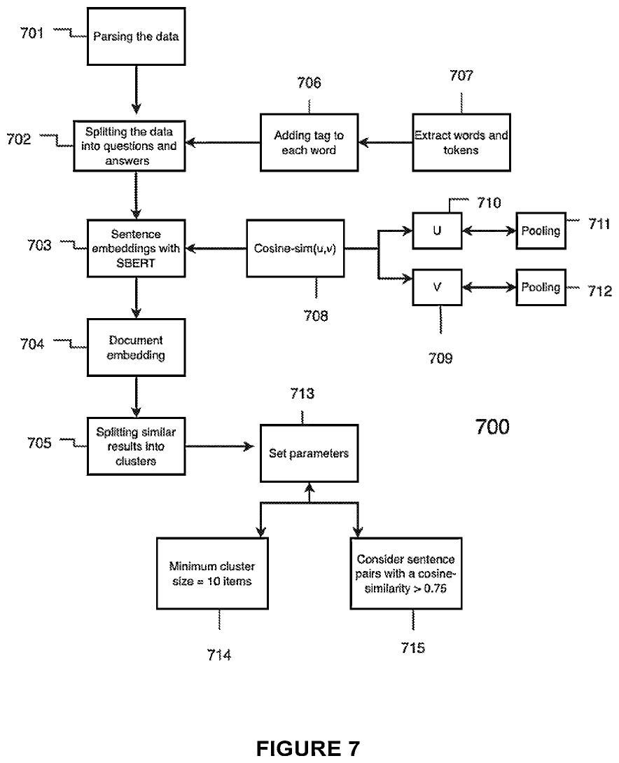

### DETAILED DESCRIPTION OF THE SEVERAL VIEW OF THE DRAWINGS

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of” “A, B, and C” should be understood as including only one of A, only one of B, only one of C, or any combination of A, B, and C.

The embodiments are designed to meet the needs of any customer-oriented company willing to automate communication with customers as far as chat conversations are concerned. In particular, the present solutions provide for a real-time contextual communication between a customer and a chatbot with and via a programmed scenario. The present solutions are further designed to provide intelligent chatbots that may be customized in a unique way thereby facilitating any user to create its own scenarios upon which the intelligent chatbot may act.

Bots, as is known in the art, refer to software programs that may operate on and/or via the Internet to perform repetitive tasks. In particular, bots are automated to run according to instruction without human intervention and accordingly may find use in imitating or replacing human user behavior, such as an interaction with a user, and especially with respect to repetitive tasks which can be made by bots more often and faster than by a human.

Regarding such user interactions, libraries of interactions (scenarios) are built as, so-called, stories that enable management and a re-building of structure for possible conversations, scenarios, stories, that are supposed to be performed by the chatbot during the interaction between the chatbot and end user via communication widget. Each scenario may be composed out of and otherwise start from several elements to enable a full and desired chatbot functionality, such as may be directed to the acquisition and/or conversation about a: (1) name, (2) description, (3) story ID, and (4) metrics. Each of the elements of the content exchanged between the chatbot and the end user may be classified as a triggering element for a chatbot scenario or may switch from one scenario to the other upon predefined triggers. Story ID, for example, enables API communication with an endpoint to create a channel of and for effective data exchange between the embodiments and the chat solution. Metrics enable summaries of conversation(s) conducted through a solution for statistical purposes. Stories are built in a complex manner thereby enabling the creation of a broad relation and interaction structure of dependencies and fallbacks. For purposes of user accessibility, the present solution(s) may provide a graphics interface as well as a JSON (JavaScript Object Notation) view to enable a structural view on and for each sequence of scenarios planned for by the user. Furthermore, the aforementioned depicts which part of the scenario is currently used and what parameters are or were extracted.

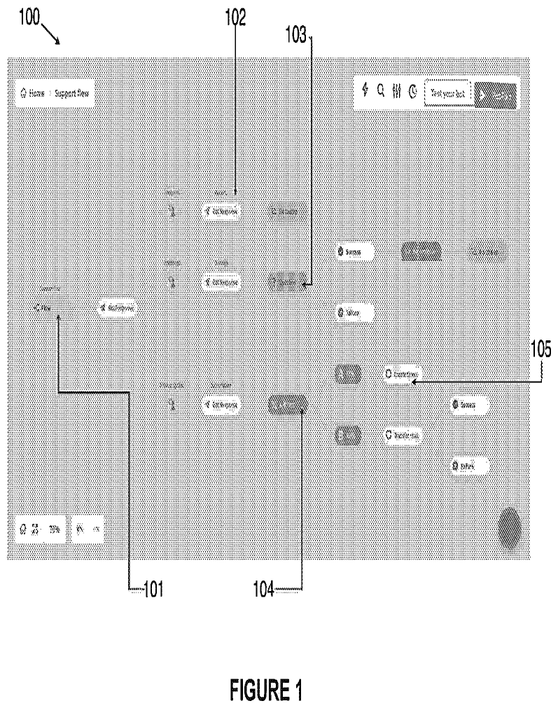

FIG. 1 depicts a graphical representation of a chatbot scenario editor that enables the user of the embodiment with the actions as: set up a flow according to the library classification (101)—support flow presented on the drawing, set up a chatbot response with predefined elements as report (102) upon triggering qualifier configured by the user, include a step of question or other actionable unit for the end user (103), perform A/B testing of the element included in the chatbot scenario configured by the user (104), send the data from the chatbot communication to an external tool via API to proceed with further action as, for example, set up a ticket for support team (105). A scenario may begin with a customer greeting such as “Hi” and proceed along a decision tree during which the end user receives the future elements of the chatbot scenario as the conversation proceeds and wherein all elements of the conversation are consistent with the scenario's intent, for example answering a pre-recorded query regarding whether the user would like to speak with an agent or whether the user requested and/or otherwise expected and/or anticipated speaking with an agent. To configure the elements of the chatbot scenario, the user is further provided with an embodiment of the invention that is responsible for chatbot scenario elements configuration. Such elements may include fallbacks (201) or a plurality of other elements based on the attribute of an element present in the chat content as for example default name and default email (202). If the chat content exchanged between the end user and chatbot mentioned the set attribute, such element may trigger a next action in the chatbot scenario.

If applicable, all content exchanged between the end user and chatbot may be interpreted using Natural Language Processing (NLP), the known branch of machine learning that helps computers understand, interpret and manipulate human language, which may be employed by embodiments of the present disclosure, and, as per the depicted story, which generates in response to a scenario where no agents are available for the user a prerecorded message such as “Unfortunately, all of our agents are busy at the moment serving other customers . . . ”, and ending with a question to the user as to whether the user would like an agent to contact him or her upon a next agent availability. A “yes” input from the user if and when interpreted may then trigger a stock answer to the effect that the user will be contacted, for example “Ok, we will contact you via . . . ”. This stock answer may include a query to the user as to how the user wishes to be contacted. If the user input is or somehow relates to “phone”, as may be interpreted with NLP, a prompting of a stock answer to confirm that such contact would be made (e.g., “Thanks? We will . . . ) and/or ensure with a follow up query for the user's preferred phone number, the input of which is interpreted and added into storage, such that it may be accommodated by an appropriately configured and arranged database. In place of answering the phone, the user may have provided other means of communication which would have been appropriately interpreted and added into storage. Had the user answered “No” to the aforementioned query of whether to be contacted by an agent, such answer would have been appropriately interpreted and then answered with a confirmation message that the user would not be contacted. Had the user provided yet another answer, such would have been interpreted and added into storage. Alternative to speaking with an agent, the user may have been engaged with a pre-recorded welcome interaction wherein certain information may be obtained from the user through pre-recorded query messages followed by NLP and/or other data gathering, and interpretation means similar to the aforementioned. By way of alternative to a welcome interaction, a fallback interaction, such as when a conversation scenario falls outside of a user's expected action, as may be with respect to speaking with an agent and providing certain information, would be available, to be executed along consistent lines as the aforementioned.

Pre-structured conversations may be programmed via ‘if then’ logic, an example of which is depicted in FIG. 1. As shown, the chatbot scenario starts with a certain flow and then proceeds to a first ‘if’ query (if reports, if settings, if subscription) 102 which if satisfied provides the user to the next stage. Depending upon the chatbot scenario criteria, a fallback or a routing to another scenario may be provided by the user and further configured in the scenario. A next example ‘if’ query is whether visitor or user details should be obtained and if so, the user would be requested to provide such data. From there, an ‘if’ query as to whether the user has indeed provided such details could ensue and if so, such details would be recorded and/or otherwise obtained and appropriately stored and/or used to trigger a next step. If it is determined that the user had not provided the requested details, this negative outcome is also recorded, and no code is stored and/or used. Alternatively, to the logic, the desired information may be initially obtained after an intro and then appropriately stored.

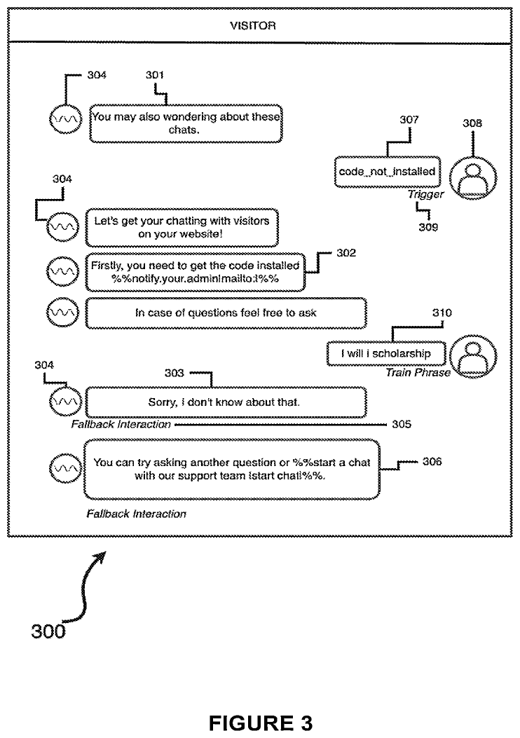

FIG. 3 discloses a conversation between chatbot and end user from the perspective of a chat widget. By way of example, the interactions concern a customer onboarding process. Such interactions are depicted and discussed herein as being in text form via a chat window, with the understanding that such interactions may take other forms of communication as envisioned by the skilled person. As shown in FIG. 3, a canned introduction statement 301 may initiate the conversation from the bot 304. This introduction may trigger the check of code installed condition (307) by the end user (308). Fulfillment of lack of fulfillment of this trigger 309 would define either to proceed with the scenario, drop it or move the end user to another scenario. A determination may be made as to whether the information was entered—in the example the chatbot scenario onboards the customer to perform certain action on the website (install code) 302. By way of example, the end user 308 in this example has not entered code, the code entered could not be installed or some other such obstacle to proceeding occurred 310 as the content sent by the end user does not match the trigger set up above (309). This prompts or triggers the bot to try alternative introductions and/or other such user directed prompts to obtain the desired information. By way of example, the user 308 may enter a response 310 which is inconsistent with the flow and/or intent of the alternative introductions; this inconsistent response triggering a fallback interaction 305 essentially explaining that the response is inconsistent (303) and questioning the user's input and logically resetting the flow of the conversation with still another query from bot to user 306. As such, the bot may be trained to engage in a first interaction with the user while having capacity and capability for any number of fallback interactions should the flow of the interaction become inconsistent with the original bot programming and/or the intention of the programming; the aforementioned being tailored towards particular user needs and otherwise limited only by the imagination of the user as with respect to potential bot-customer interactions.

Example methods of using embodiments of the present disclosure that begin with defining stories and interactions are set out in the following Figures. As implemented according to embodiments of the present invention, Natural Language Processing may be supported by the innovative usage of modified TF-IDF (term frequency-inverse document frequency) which enables modification of a weight function in adynamic manner that results in a more efficient text classification. The main functionality is based on a search, matching and response generating ability which is supported by entities—e.g., subclasses of responses and qualifiers—and is based on NLP. Each entity can be pre-designed by a user and further defined according to current needs. An entity constitutes a collection of variable data which, based on a confidence score, can either link to a particular element of a scenario or return a “null” and re-ask a request for additional information and inclusion of such data into the system. Such may typically arise out from a user interacting with a bot.

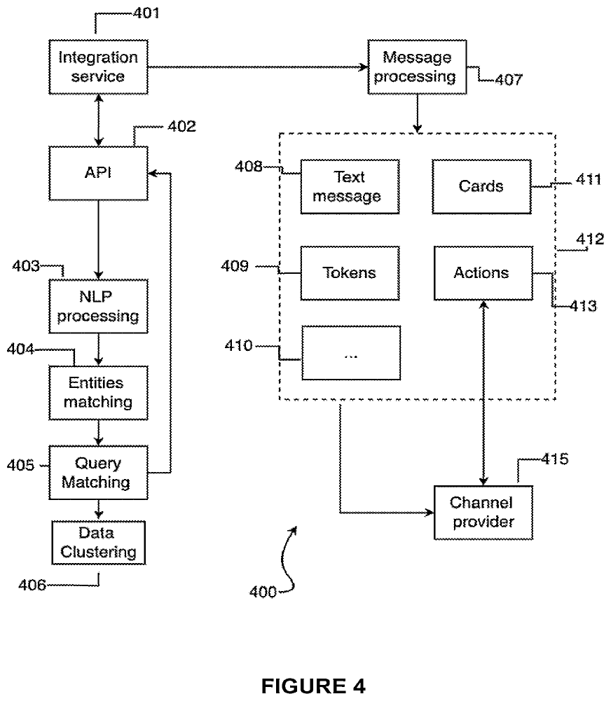

Functional elements of stories build upon a matching system that starts with creation of scenarios and integration of embodiments with any channel provider through API and/or an own integration (401). With general reference to FIG. 4 as a depiction of an example of bot-end user communication via a chat window as the outcome of message processing (407), the end user may enter any statement into the chat window (described as a channel provider). Such information is transferred through API (402) to the channel provider (415) and then via integration sent to the present embodiment of the invention. The content sent by the end user may include any type of test message (408), cards including a combination of multimedia data (411), tokens (409), actions or triggers, links (413) or any other type of content or activity that is enabled via channel provider delivering chat widget (410). Such processing includes Natural Language Processing (403), Entities Matching (404), Query Matching (405) and potentially other types of Machine Learning if applicable. Furthermore, the system and method steps of the embodiment of the invention include the possibility to cluster the data (406) exchanged with the end user via chat window to further categorize it and propose responses during chatbot scenario building by the embodiment user. At the stage of the Query Matching (405), the present embodiments may call back their API (402) to send a webhook back to the channel provider with an adequate response, trigger or fallback action.

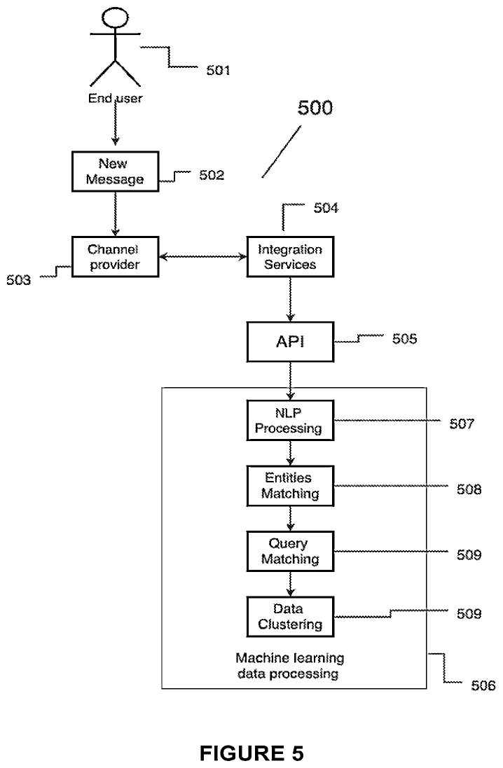

A user initiating process flow 501 is depicted in FIG. 5. A user 512 generates a new message 502, by means known in the art, consistent with the communication means employed by the user 501 and as enabled by the communication channel provider 503. For example, the user 501 may open a window 503, type in a message 502, send it via a chat widget in which an inventive chatbot according to embodiments of the present disclosure may be installed, have access and/or otherwise be integrated. Such a new message 502 is received at a channel provider 503. The channel provider 503 may be configured and arranged to be integrated with the chatbot thereby facilitating a number of integration services 504, some of which have been detailed above. The new message sent by the end user (501) is further analyzed by the constituent elements of the invention including machine learning data processing as NLP, titles matching, query matching or data clustering.

All of the elements as mentioned above, including machine learning processing receives and sends data to the channel provider thanks to the API use.

A system process flow, including application of the agent application, is depicted in FIG. 4 and is further enabled by API use with the integration service. The integration service 401 communicates with the agent application via API 402, the agent application of any other third-party element included in the communication flow as may benefit from the output of processed data with at least one of NLP processing 403, entities matching 404, query matching 405 and machine learning or data clustering 406

By creating a scenario based on certain entities with a confidence score, an end user is able to effectively communicate with the agent and/or company and receive help with his or her particular needs. Bots can conduct multilayer conversations with complex plots and questions. Additionally, during the course of its existence, language classification may improve and bring even more efficient results due to the machine learning process. With the addition of confidence scoring and the like, the innovative storyline programming of the bots is still further improved thereby expanding applicability of the herein disclosed technologies.

Matching systems are responsible for pairing user input with a User Says field. This system is based upon weighting chosen scoring and leading either to the next element of a scenario or a fallback as for example depicted in 201. If the score is equal to or higher than the setup Confidence Score, the bot response is triggered; consequently, choosing the right matching systems can be crucial for the seamless conversation flow and interactions. If the score is less than a chosen confidence score, such response cannot be properly classified, as in accordance with the scheme presented in, which then leads to the fallback action with an example of the story ending with fallback action.

There are different types of interactions defined by the user's needs, for example invite interactions responsible for greetings at the beginning of a conversation. A next example is a fallback interaction, which takes place when a bot is unable to classify a particular response or request and match it with an adequate part of the story. Such fallback interaction may be a global—default for the whole scenario or contextual—then it depends on a conversation stage and end user reactions. Furthermore, it may be created and adjusted at each stage of a scenario making. Then, the story maker can decide upon a next step, such as showing a general message when the bot cannot match the user query with any of the interaction(s). The interaction prompts the user to suggest rewording the phrase, showing possible options or performing specific actions. Such Callback actions as well as responses may be customized by a user. To customize it, there is a possibility to base chatbot interactions on a confidence score. This is a unique and custom innovation which amounts to addressing a need to interact with and via natural language. It may accept particular mistakes as belonging to the natural human language, nevertheless, the scenario-maker is able to limit such levels of confidence. The confidence score defines how precisely a bot will interpret what the end user says and constitutes a threshold that determines what the lowest acceptable matching score to trigger an interaction may be. For example, a confidence score may be set up in the range of 0-1, wherein 0 means 0%, 0.5=50% and 1=100%. It is possible to test different scorings in case of different stories as may be needed. Adequacy of technical fluency is provided by modifying a longest common subsequence. The disclosed solution constitutes an innovative application of the Levenshtein distance. As is known in the art, the Levenshtein distance is the minimum number of single-character edits (insertions, deletions, or substitutions) required to change one word into another word. Comparison of supplies at entities used in the embodiment of the invention is enabled due to application of Sorensen-dice coefficient, namely, as is known in the art, a statistic used to gauge the similarity of two samples.

FIG. 5 depicts a process flow instigated by the generation of a new message 502 and its subsequent communication to an integration service 503. The integration service may comprise at least one of a chat widget, helpdesk, and other such services as known to the skilled person. Such a message is then communicated via API 505 to NLP processing 507. Should it be determined at this stage that the message includes user entities and an “if yes” condition for performing an action exists, such as the presence of some user entities or other such data that may be used to identify the user, a longest common sequence may be modified. By way of example, certain user identification data may include location, e.g., Alaska; eating preferences, e.g., vegetarian; and vocation, e.g., software programmer. Such and related information may then be used to build a user profile as well as be integrated into stories and/or scenarios for subsequent determination of best sequences of communication. If an insufficient amount of data is present and/or otherwise obtained, the message is subjected to a confidence scoring, namely, algorithm optimization and Sorensen-Dice coefficient, from which a resolution of message content useful data may be affected. If such is successful and matched results are obtained, the process returns to the integration service 704 via an appropriately programmed and readied bot. Where such is not successful, certain fallback positions are taken into consideration, as detailed above, for the bot to take back to the integration service.

There are two categories of entities used for entity matching (508), namely: (1) user made entities; and (2) system entities which are pre-included in the system to raise fluency of the user experience as are the practical possibilities to govern bots. Such system entities constitute groups collecting detection of numbers (including only integers and/or only classification), email addresses, phone numbers, detection of synonyms to words such as “yes” or “no”, entities able to detect URL addresses, temperature and so-called system entity “any”. Apart from the very last one, the present embodiments possess an own built-in detection of variables which may occur as a foreseeable value in the course of a regular conversation. Such functionality should enable any user to create its own bot with no necessity to start or become weighted down with complex programming and data collection concerning catalogs of numbers as well as typically shared contact details. Elements listed beforehand as an entity “any” is an intelligent system which enables a bot to take scheduled action once a particular phrase cannot be matched by NLP with any other entity present at the embodiment. In such a situation, there is a possibility to reassign a variable from end user response to the statement sent by a bot to create a contextual response where wording included by the end user is applied. For example, entity “any” may be used to detect US Postal Code which occurs in different configurations and contains variable signs. In case of each Entity, both user-made, scenario flow may be assigned due to the exact meaning of the wording as well as synonyms. Embodiments herein are prepared to support multiple languages and due to accelerated computational complexity, it is possible to execute multiplayer scenarios in a real-time responses' manner.

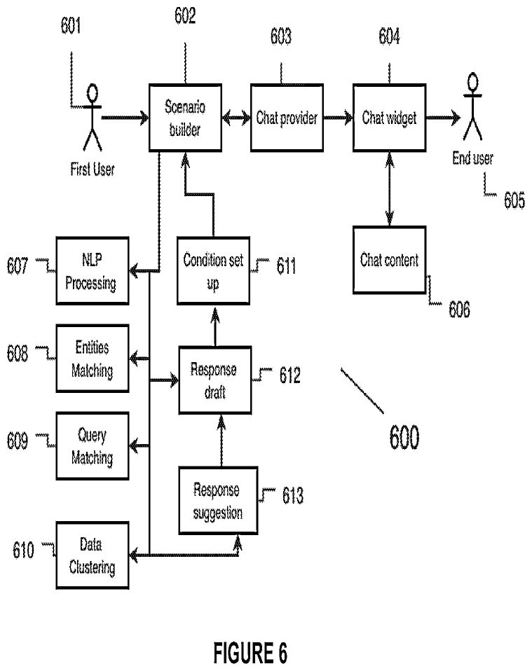

FIG. 6 further presents the detailed flow of interaction between the end user and chatbot scenario with data clustering being included. The content sent by the end user (605) triggers the action of the system and method steps that analyze the chat content (606) exchanged over chat widget (604) delivered by the chat provider (603) as the outcome of scenario configured by the first user (601) in the scenario builder (602). Scenario builder includes actions that are triggered by a plurality of factors including NLP processing (607), entities matching (608), query matching (609). Those elements listed aim to trigger action or send content drafted (612) by the first user (601) upon set up condition (611). The other elements in the system and method disclosed by this invention include to suggest the possible response (613) to the first user (601) based on the analysis of prior communication with a group of users performed by the first user (601). Such a suggestion is the outcome of processing of clustered data (610) of the chat content (606). The chat content that is analyzed by the embodiment of the invention is based on the selected portion of data saved in the database beforehand. Consequently, the suggestion to the scenario at the time of chat scenario making is based on the cluster of data composed out of the chat content saved in the database in the form of archive.

To enable the suggestion of response to the first user (613) the embodiment of the invention uses clustered data. To cluster the data, the embodiment of the invention starts with the step of parsing the data (701) which means organization of the data composed of the chat content. To provide efficient suggestions the data needs to be filtered and split into subcategories of question and answers (702) which will further help the embodiment user to select the suggested content appropriately. Such action is possible thanks to the extraction of words and tokens (707) that will further enable tagging (706) of each word. Tagged words may be further processed by the embodiment of the invention to provide matching options according to the programmed conditions. The next step of the embodiment of the invention includes sentence embeddings with SBERT wherein a sentence encoder is used, for which similarity is measured using Spearman correlation between cosine-similarity of the sentence embeddings and tags performed in the step 706. Further document embedding organizes the cataloged data 704 and leads to the creation of clusters of data based on similarity (705). The clustered groups of data are built upon parameters 713 regarding size as minimum cluster size (714) and sentence pairs with a cosine-similarity >0.75 (715). Furthermore, the cosine similarity for chat content assessment is based upon the vectors in inner product space (710, 709) and further on pooling action that retrieve the data (711, 712). Data processed in the above-disclosed pattern result in a library of suggestions offered to the embodiment user during chatbot scenario building. Provision of such method steps and system elements ensure faster access to information and possibility of better customer support thanks to the intelligent system offering a support with the selection of best performing chat responses. The user of the embodiment is able to trigger the chat content clustering and further turn off such option upon individual need.

As used herein, entities shall be understood as libraries may be updated on a regular, dynamic base balanced with a confidence score.

The present embodiments offer a solution which may be implied in any application which enables API. A flow of such information is presented by the figures, with FIG. 6 depicting a simplified form of how an embodiment uses communication between chat API and when Natural Language Processing matches a new message which is directed to the embodiment by integration with a channel provider.

This and other embodiments facilitate intelligent machine learning processes by application of Naive Bayes classifier which enables application of probabilistic methods during request and response classification. By adding new classifiers and extending confidence scoring, a bot created through the present embodiments becomes more intelligent and can assess customer reactions with visibly higher adequacy. Due to API based integration ability, it may cooperate with any tool or solution.

The figures are merely schematic representations and serve only to explain the invention. Elements that are identical or have the same effect are consistently marked with the same reference signs.

What is claimed is:

1. A communication system for real-time communication between at least a first user and a second user, the system including a chatbot operating in connection with an Internet browser, the system comprising:
A scenario builder arranged on a processor of a first user and configured to facilitate the building of a scenario;
A chatbot infrastructure configured to send messages by the first user as an element of the scenario and to respond to messages from the second user within an instant communication channel based on a scenario sequence configured by the first user;
Data storage configured to save scenarios, messages, and responses created by the first user and sent by the chatbot infrastructure;
An application programming interface configured to facilitate communication between the scenario builder, chatbot infrastructure, and service providers of instant messaging systems;
API configured to facilitate communication between chatbot infrastructure and communication channels;
A data parsing mechanism arranged on a server, the data parsing mechanism configured to cluster data of the chat content and provide a suggestion for chatbot response;
Wherein, the scenario comprises a sequence of messages based upon conditions predefined by the first user;
Wherein, the API further includes API fallbacks, JSON structure, and webhooks; and
Wherein, the chat content includes all messages sent to and by the chatbot.

2. The system according to claim 1, wherein the scenario builder is configured to:
receive content entered by the first user in the scenario builder;
enable conditional communication upon triggers selected by the first user;
enable a plurality of paths that constitutes a scenario;
remove elements of the scenario upon the first user selection
include messages sent by the chatbot infrastructure;
respond to the messages sent by the second user of the invention;
wherein the scenario builder further comprises a front end and a backend infrastructure connected to a networked database; and
wherein the chatbot scenario further comprises content elements comprising audio visual content, triggers, and programmed reactions.

3. The system according to claim 1, wherein the chatbot infrastructure data storage is configured to:
save scenarios created by the first user in the scenario builder in the data storage;
adjust scenarios created by the first user in the scenario builder based upon changes implemented by the first user;
operate in a networked environment; and
issue and receive API calls and webhooks.

4. The system according to claim 1, wherein the application programming is configured to:
issue API calls and webhooks that refer to an action performed by the chatbot while the chatbot proceeds with a chatbot scenario;
receive API calls from external service providers; and
trigger actions in the scenario built by the first user upon API calls and webhooks sent by external service providers.

5. The system according to claim 1, wherein the data parsing mechanism is further configured to:
set up a minimum chat content size and a maximum chat content size;
embed sentences from the chat content to use the SBERT Sentence transformer;
cluster similar sentences into groups based on the similarity between chat contents;
extract words and other tokens from chat content strings;
process a sequence of words and attach a tag to each element of the chat content;
classify the chat content into subcategories of questions and answers; and
wherein other tokens include links, images, voice messages or other unqualified chat content.

6. The system according to claim 2, wherein the application programming interface is configured to scenario is configured to:
assign a sequence of the scenario based on a condition configured by the first user;
reassign the scenario if the response of the second user does not match the scenario configured by the first user;
cease the scenario sending upon direct request from the first user sent by the user interface; and
wherein the user interface comprises frontend infrastructure configured to further process information to cease sending through the backend infrastructure.

7. The system according to claim 2, wherein the conditions in the scenario builder are configured to:
trigger a scenario based on human language analysis;
trigger a scenario based on a Sorensen-dice coefficient;
trigger a scenario based on a Levenshtein distance;
introduce more than one fork in the scenario created in the scenario builder by the first user that is based upon the condition;
to accept values exact, similarly, or interpreted as a value in the scenario; and
perform AB testing on the content defined by the first user.

8. The system according to claim 2, wherein the scenario builder is configured to:
on the first user processor and within the browser;
operate with the user input;
accept alphanumeric content;
support the uploading of audio-visual content; and
enable the use of hyperlinks and direct redirects to other websites.

9. The system according to claim 2, wherein the chatbot infrastructure is configured to:
operate within the instant messaging channel;
send messages to initiate the communication with the second user; c. respond to the messages sent by the second user;
send textual content, audio-visual elements, hyperlinks according to the scenario; and
send messages and responses according to the scenario.

10. The system according to claim 10, wherein the minimum chat content size includes 10 independent communication items and wherein the system considers sentence pairs with a cosine similarity larger than 0.75.

11. A method for real-time communication between at least a first user and a second user using a communication system including a chatbot operating in connection with an Internet browser, the method comprising the steps of:
configuring the scenario builder on the processor of the first user;
sending messages by the first user as an element of the scenario;
responding to the second user messages within an instant communication channel based on a scenario sequence configured by the first user;
storing data including scenarios, messages, and responses created by the first user and sent by the chatbot infrastructure in the networked database;
facilitating communication between the scenario builder, chatbot infrastructure and service providers of instant messaging systems with a networked infrastructure; and
parsing data arranged on server configured to cluster the data of the chat content to provide a suggestion for chatbot response;
wherein, the scenario created in the scenario builder by the first user comprises a sequence of messages based upon conditions predefined by the first user; and
wherein, the chat content includes all messages sent to and by the chatbot.

12. A method according to claim 11, further comprising the steps of:
receiving a content entered by the first user in the scenario builder;
creating communication upon triggers selected by the first user in the scenario builder;
enabling a plurality of paths that constitutes a scenario;
removing elements of the scenario upon the first user selection; e. adjusting the scenario based on the messages sent by the chatbot infrastructure and responses by the second user;
responding to the messages sent by the second user of the invention; g. wherein the scenario builder further comprises a front end and a backend infrastructure connected to a networked database; and
wherein the chatbot scenario further comprises content elements comprising audio-visual content, triggers, and programmed reactions.

13. A method according to claim 11, further comprising the steps of:
saving scenarios created by the first user in the scenario builder;
adjusting scenarios created by the first user in the scenario builder based upon changes implemented by the first user;
operating in a networked environment; and
issuing and receiving API calls and webhooks.

14. A method according to claim 11, further comprising the steps of:
issuing API calls and webhooks that refer to an action performed by the chatbot while the chatbot proceeds with a chatbot scenario;
receiving API calls from external service providers; and
triggering actions in the scenario built by the first user upon API calls and webhooks sent by external service providers.

15. The method according to claim 11, wherein the parsing data is further comprising the steps of:
setting up a minimum chat content size and a maximum chat content size;
embedding sentences from the chat content configured to use the SBERT Sentence transformer;
clustering similar sentences into groups based on the similarity between chat contents;
extracting words and other tokens from chat content strings;
process a sequence of words and attach a tag to each element of the chat content;
classifying the chat content into subcategories of questions and answers;
wherein other tokens include links, images, voice messages or other unqualified chat content.

16. A method according to claim 12, further comprising the steps of:
assigning a sequence of the scenario based on a condition configured by the first user;
reassigning the scenario if the response of the second user does not match the scenario configured by the first user;
ceasing the scenario sending upon direct request from the first user sent by the user interface; and
wherein the user interface comprises frontend infrastructure configured to further process information to cease sending through the backend infrastructure.

17. A method to claim 12, further comprising the steps of:
triggering a scenario based on human language analysis;
triggering a scenario based on a Sorensen-dice coefficient;
triggering a scenario based on a Levenshtein distance;
introducing more than one fork in the scenario-based upon the condition;
performing AB tests based on the content defined by the first user; and
wherein the scenario is configured to accept values that are exact, similar, or interpreted as a value in the scenario.

18. A method to claim 12, further comprising the steps of:
operating on the first user processor and within the browser;
operating with the user input;
enabling at least the first and the second user to enter alphanumeric content; d. supporting the uploading of audio-visual content; and
enabling the first user to use hyperlinks and direct redirects to other websites as a part of the scenario.

19. A method to claim 12, further comprising the steps of:
operating within the instant messaging channel;
sending messages to initiate the communication with the second user; c. responding to the messages sent by the second user;
sending textual content, audio-visual elements, hyperlinks according to the scenario; and
sending messages and responses according to the scenario.
